(19) United States
(12) Patent Application Publication
(10) Pub. No.: US 2026/0159701 A1
(43) Pub. Date: Jun. 11, 2026

(54) ULTRAVIOLET CURING RESIN COMPOSITION, COATED OPTICAL FIBER, COLORED OPTICAL FIBER, OPTICAL FIBER RIBBON, METHOD FOR MANUFACTURING COATED OPTICAL FIBER, METHOD FOR MANUFACTURING COLORED OPTICAL FIBER, AND METHOD FOR MANUFACTURING OPTICAL FIBER RIBBON

(71) Applicant: Lightera Japan Co., Ltd., Tokyo (JP)

(72) Inventors: Kuniaki ISHIZUKI, Tokyo (JP); Mitsuhiro IWAYA, Tokyo (JP); Takahiro SAKURAI, Tokyo (JP); Hideyuki OTSUKA, Tokyo (JP); Akira TAKAHASHI, Tokyo (JP)

(73) Assignee: Lightera Japan Co., Ltd., Tokyo (JP)

(21) Appl. No.: 19/404,147

(22) Filed: Dec. 1, 2025

(30) Foreign Application Priority Data
Dec. 11, 2024 (JP) 2024-217092

(51) Int. Cl. C09D 5/00; C03C 25/1065; C03C 25/40; C03C 25/475; C09D 175/14; G02B 6/44

(52) U.S. Cl. CPC C09D 5/002; C03C 25/1065; C03C 25/40; C03C 25/475; C09D 175/14; G02B 6/448; G02B 6/4482

(57) ABSTRACT

An ultraviolet curing resin composition for forming a primary layer in a colored optical fiber that includes a bare optical fiber, the primary layer covering the bare optical fiber, and a secondary layer covering the primary layer, comprising: a silane coupling agent that reversibly bonds the bare optical fiber and the primary layer.

### CROSS-REFERENCE TO RELATED APPLICATIONS

This application claims the benefit of priority to Japanese Patent Application No. 2024-217092, filed on Dec. 11, 2024, the entire contents of which are incorporated herein by reference.

### BACKGROUND OF THE INVENTION

### Field of the Invention

The present invention relates to an ultraviolet curing resin composition, a coated optical fiber, a colored optical fiber, an optical fiber ribbon, a method for manufacturing the coated optical fiber, a method for manufacturing the colored optical fiber, and a method for manufacturing the optical fiber ribbon.

### Description of the Related Art

A technique for forming a primary layer covering a bare optical fiber, a secondary layer covering the primary layer, and a colored layer covering the secondary layer using an ultraviolet curing resin in optical fibers is known (Japanese Patent Laid-Open No. 2005-162522).

### SUMMARY OF THE INVENTION

In typical optical fibers, a bare optical fiber and a primary layer are covalently bonded to each other via a silane coupling agent (Japanese Patent No. 3487314). Therefore, once the primary layer is peeled off the bare optical fiber, it is difficult to recover the peeling. When the primary layer is peeled off the bare optical fiber (glass) in the optical fiber, the characteristics of the optical fiber are significantly deteriorated.

In view of the above-described problems, it is an object of the present invention to provide an ultraviolet curing resin composition, a coated optical fiber, a colored optical fiber, an optical fiber ribbon, a method for manufacturing an optical fiber, a method for manufacturing a colored optical fiber, and a method for manufacturing an optical fiber ribbon that can recover from a state in which a primary layer is peeled off a bare optical fiber.

According to one aspect of the present invention, provided is an ultraviolet curing resin composition for forming a primary layer in a colored optical that includes a bare optical fiber, the primary layer covering the bare optical fiber, and a secondary layer covering the primary layer, comprising: a silane coupling agent that reversibly bonds the bare optical fiber and the primary layer.

According to an aspect of the present invention, there is provided a coated optical fiber including a bare optical fiber; a primary layer that is formed of a first ultraviolet curing resin composition and covers the bare optical fiber; and a secondary layer that is formed of a second ultraviolet curing resin composition and covers the primary layer, wherein the first ultraviolet curing resin composition includes a silane coupling agent that reversibly bonds the bare optical fiber and the primary layer.

According to another aspect of the present invention, there is provided a method for manufacturing a coated optical fiber including a step of drawing a bare optical fiber from an optical fiber preform; a step of forming a primary layer by applying a first ultraviolet curing resin composition around the bare optical fiber; and a step of forming a secondary layer by applying a second ultraviolet curing resin composition around the primary layer; and a step of irradiating ultraviolet light to cure the first ultraviolet curing resin composition and the second ultraviolet curing resin composition, wherein the first ultraviolet curing resin composition includes a silane coupling agent that reversibly bonds the bare optical fiber and the primary layer.

According to the present invention, it is possible to provide an ultraviolet curing resin composition, a coated optical fiber, a colored optical fiber, an optical fiber ribbon, a method for manufacturing the coated optical fiber, a method for manufacturing the colored optical fiber, and a method for manufacturing the optical fiber ribbon that can recover from a state in which a primary layer is peeled off a bare optical fiber.

### BRIEF DESCRIPTION OF THE DRAWINGS

FIG. 1 is a cross-sectional view of a colored optical fiber according to an embodiment.

FIG. 2 is a cross-sectional view of a coated optical fiber according to the embodiment.

FIG. 3 is a schematic diagram illustrating a manufacturing apparatus used in a method for manufacturing the colored optical fiber according to the embodiment.

FIG. 4 is a schematic diagram illustrating a manufacturing apparatus used in the method for manufacturing the colored optical fiber according to the embodiment.

FIG. 5 is a cross-sectional view of an optical fiber ribbon according to the embodiment.

FIG. 6 is a schematic diagram of a ribbon forming apparatus used in a method for manufacturing the optical fiber ribbon according to the embodiment.

FIG. 7 is a flowchart of a method for manufacturing the colored optical fiber and the optical fiber ribbon according to the embodiment.

FIG. 8 is a diagram illustrating results of a delamination recovery test in an example of the coated optical fiber according to the embodiment.

FIG. 9 is a diagram illustrating results of a delamination recovery test in a comparative example of the coated optical fiber according to the embodiment.

### DESCRIPTION OF THE EMBODIMENTS

Hereinafter, embodiments of the present invention will be described in detail with reference to the drawings. Throughout the drawings, components having the same function are labeled with the same references, and the repetitive description thereof may be omitted.

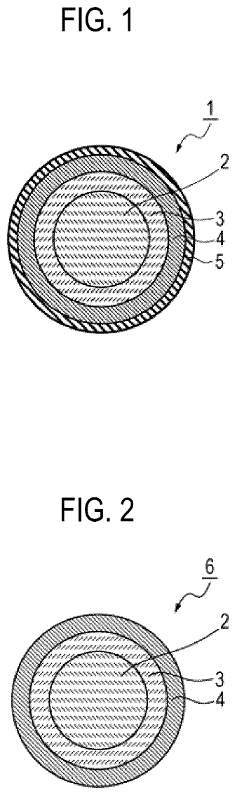

FIG. 1 is a cross-sectional view of a colored optical fiber 1 according to the present embodiment. The colored optical fiber 1 includes a bare optical fiber 2, a primary layer 3 covering the outer periphery of the bare optical fiber 2, a secondary layer 4 covering the outer periphery of the primary layer 3, and a colored layer 5 covering the outer periphery of the secondary layer 4. The bare optical fiber 2 is covered with three covering layers of the primary layer 3, the secondary layer 4, and the colored layer 5. FIG. 2 is a cross-sectional view of the coated optical fiber 6 according to the present embodiment. The coated optical fiber 6 is a fiber in a state before the colored layer 5 is formed.

The bare optical fiber 2 is formed of quartz glass or the like, for example, and transmits light. In the present specification, the bare optical fiber 2 is also simply referred to as “glass”. The primary layer 3, the secondary layer 4, and the colored layer 5 are each formed by curing an ultraviolet curing resin by irradiation with ultraviolet light (UV). The ultraviolet irradiation is performed, for example, by using a mercury lamp or a UV-LED at an appropriate illuminance and irradiation dose as needed.

The primary layer 3 is a soft layer and has a function of buffering an external force applied to the bare optical fiber 2. The secondary layer 4 is a hard layer and has a function of protecting the bare optical fiber 2 and the primary layer 3 from an external force.

The colored layer 5 is colored to identify the colored optical fiber 1. The colored secondary layer 4 may be the outermost layer of the colored optical fiber 1. When the secondary layer 4 is colored, the secondary layer 4 is colored by adding a coloring agent obtained by mixing a pigment, a lubricant, or the like to the secondary layer 4. The content of the coloring agent in the colored secondary layer 4 can be appropriately determined depending on the content of the coloring agent contained in the coloring agent, the kind of other components such as the ultraviolet curing resin, or the like.

In the present embodiment, the primary layer 3, the secondary layer 4, and the colored layer 5 are formed of a composition (Hereinafter, this is referred to as “ultraviolet curing resin composition”) containing an ultraviolet curing resin as a main component. The ultraviolet curing resin is, for example, a urethane acrylate (methacrylate)-based ultraviolet curing resin. The urethane acrylate (methacrylate)-based ultraviolet curing resin is composed of an oligomer, a monomer, or the like. The ultraviolet curing resin composition appropriately contains additives such as a photoinitiator, a photosensitizer, a chain transfer agent, an ultraviolet absorber, an antioxidant, a silane coupling agent, a lubricant such as silicone, and a pigment such as titanium oxide. The physical properties, such as the conversion, Young's modulus, and elongation at break, can be controlled by appropriately adjusting the components of the ultraviolet curing resin composition.

Examples of the photoinitiator include 1-hydroxycyclohexyl-phenyl ketone, 2,4,6-trimethylbenzoyl-diphenylphosphine oxide, 2,4,6-trimethylbenzoyl bis (p-tolyl) phosphine oxide, Ethyl phenyl(2,4,6-bis(2,4,6-trimethylbenzoyl)phosphinate, trimethylbenzoyl)phenylphosphine oxide, 2-methyl-1-[4-(methylthio)phenyl]-2-morpholinopropan-1-one) and the like. The type of the photoinitiator is not limited to those described above.

By adding a photoinitiator or a photosensitizer, UV curing using a UV-LED can be efficiently performed. Examples of the photoinitiator having an absorption region at a wavelength of 300 nm or more include 2,4,6-trimethylbenzoyl-diphenylphosphine oxide, 2,4,6-trimethylbenzoyl bis (p-tolyl) phosphine oxide, bis(2,4,6-trimethylbenzoyl)phenylphosphine oxide. Examples of the photosensitizer having an absorption region at a wavelength of 300 nm or more include 2,4-diethyl-9H-thioxanthen-9-one, 2-isopropylthioxanthone and the like.

As a material for forming the primary layer 3, an ultraviolet curing resin composition obtained by adding a silane coupling agent to an ultraviolet curing resin is used. A typical silane coupling agent has a functional group for irreversibly bonding the bare optical fiber 2 and the primary layer 3. By adding the silane coupling agent to the ultraviolet curing resin, the bare optical fiber 2 and the primary layer 3 are sufficiently adhered to each other. In the present embodiment, the term “irreversible bond” means a bond that does not cause recombination once cleaved. Irreversible bonds include, for example, covalent bonds such as carbon-carbon covalent bonds and carbon-sulfur covalent bonds. Therefore, when the silane coupling agent is added to the ultraviolet curing resin, if the bond is once cut by an external stimulus or the like, the portion cannot be recombined.

Examples of the general silane coupling agent include (3-mercaptopropyl) trimethoxysilane, (3-mercaptopropyl) triethoxysilane, Vinyltrimethoxysilane, Allyltrimethoxysilane, 3-(trimethoxysilyl) propyl methacrylate, and (3-Isocyanatopropyl) trimethoxysilane). The type of the silane coupling agent is not limited thereto.

In addition, in the present embodiment, the term “reversible bond” means a bond that can be bonded again even if it is once cleaved. Examples of the reversible bond include a hydrogen bond, a dynamic covalent bond, an ionic bond, and a bond by an intermolecular force. In the present embodiment, as a material for forming the primary layer 3, an ultraviolet curing resin composition to which a silane coupling agent for reversibly bonding the cured primary layer 3 and the bare optical fiber 2 is added is used. As a result, even when the bare optical fiber 2 and the primary layer 3 are sufficiently adhered to each other and the bond therebetween is cut by an external stimulus or the like, recombination occurs, and thus it is expected that peeling is recovered. Hereinafter, in the present embodiment, unless otherwise specified, the “silane coupling agent” refers to a silane coupling agent that reversibly bonds the primary layer 3 and the bare optical fiber 2.

As the silane coupling agent of the present embodiment, a silane coupling agent having a portion where a urethane bond is formed and a portion to form a hydrogen bond in the ultraviolet curing resin constituting the primary layer 3 can be considered. The hydrogen bond is an interaction formed by a hydrogen atom covalently bonded to an atom having a high electronegativity (e.g., nitrogen, oxygen, sulfur, chlorine, or fluorine) and a lone electron pair of an atom having a high electronegativity. In the molecular structure of the silane coupling agent, examples of the portion that forms a hydrogen bond with the portion where a urethane bond is formed in the primary layer 3 include a functional group such as a carboxy group, a hydroxy group, or an ester group, and a portion where a urethane bond or a urea bond is formed.

The method for forming the reversible bond is not limited to the above-described method. For example, a functional group capable of forming a reversible bond may be introduced in advance into both of the ultraviolet curing resin constituting the primary layer 3 and the silane coupling agent. For example, a bond-exchangeable dynamic bond, such as a disulfide bond or diarylbibenzofuranone, may be introduced into both the ultraviolet curing resin and the silane coupling agent. Furthermore, a molecular structure in which a predetermined portion of the ultraviolet curing resin and a predetermined portion of the silane coupling agent can be reversibly bonded (bonded by ionic bond or intermolecular force) may be incorporated into one or both of the ultraviolet curing resin and the silane coupling agent.

In addition, to accelerate the reaction between the silane coupling agent and the bare optical fiber 2, an additive (photoacid generator) that generates an acid upon ultraviolet irradiation may be appropriately added. Examples of the photoacid generator include CPI-200K, manufactured by San-Apro. The type of the photoacid generator is not limited thereto.

In order to adjust the Young's modulus of the ultraviolet curing resin, a mercapto-containing compound may be added. Examples of mercapto-containing compounds include Isooctyl 3-mercaptopropionate, Ethyl mercaptan, 1-butanethiol, 1-heptanethiol, 1-undecanethiol, 4-hydroxybenzenethiol, (2-mercaptoethyl) pyrazine, 2,3-butanedithiol, 3-methyl-2-butanethiol, 3-mercapto-1,2,4-triazole, 1,3,4-thiadiazole-2-thiol, isobutyl mercaptan, 4-methoxy-α-toluenethiol, 4,4′-biphenyldithiol, Trimethylsilylmethanethiol, 1,4-butanedithiol, 1,8-octanedithiol, 3-ethoxybenzenethiol, pentaerythritol tetra(3-mercaptopropionate)), and the like. The kind of the mercapto-containing compound is not limited thereto. In addition, not only the mercapto-containing compound but also a compound that reacts with the ultraviolet curing resin to stop polymerization may be added.

The diameter of the coated optical fiber 6 may be greater than or equal to 80 μm and less than or equal to 150 μm, and preferably greater than or equal to 124 μm and less than or equal to 126 μm. The thickness of the primary layer may be greater than or equal to 5 μm and less than or equal to 60 μm. The thickness of the secondary layer may be greater than or equal to 5 μm and less than or equal to 60 μm. The thickness of the colored layer may be about several micrometers.

Here, the diameter of the coated optical fiber 6 can be determined by the sum of the diameter of the bare optical fiber 2, the length twice the thickness of the primary layer 3, and the length twice the thickness of the secondary layer 4. Therefore, the diameter of the bare optical fiber 2, the thickness of the primary layer 3, and the thickness of the secondary layer 4 can be selected so that the diameter of the coated optical fiber 6 is about 120 to 280 μm.

FIG. 2 is a schematic diagram illustrating a manufacturing apparatus 10 used in a method for manufacturing the colored optical fiber 1 according to the present embodiment. In FIG. 2, the manufacturing apparatus 10 includes a heating apparatus 20, a primary layer covering apparatus 30, a secondary layer covering apparatus 40, a guide roller 45, and a winding apparatus 50.

The optical fiber preform BM is made of, for example, quartz-based glass, and is manufactured by a well-known method such as a VAD method, an OVD method, or an MCVD method. The heating apparatus 20 includes a heater 21. The heater 21 may be any heat source, such as a tape heater, a ribbon heater, a rubber heater, an oven heater, a ceramic heater, a halogen heater, or the like. The end portion of the optical fiber preform BM is heated and melted by using the heater 21 arranged around the optical fiber preform BM, and a bare optical fiber 2 is drawn by drawing.

Under the heating apparatus 20, a primary layer covering apparatus 30 is provided. The primary layer covering apparatus 30 includes a resin application apparatus 31 and an ultraviolet irradiation apparatus 32. The resin application apparatus 31 holds an ultraviolet curing resin composition (Hereinafter, this is referred to as “primary layer material”) as a covering material for forming the primary layer 3. The primary layer material is applied to the bare optical fiber 2 drawn from the optical fiber preform BM by the resin application apparatus 31.

The ultraviolet irradiation apparatus 32 is provided under the resin application apparatus 31. The ultraviolet irradiation apparatus 32 includes any ultraviolet light source such as a metal halide lamp, a mercury lamp, or an UV-LED. The primary layer material is applied to the bare optical fiber 2 by the resin application apparatus 31 and the bare optical fiber 2 enters the ultraviolet irradiation apparatus 32, and the primary layer material is irradiated with ultraviolet light. As a result, the primary layer material is cured to form the primary layer 3.

Under the primary layer covering apparatus 30, the secondary layer covering apparatus 40 is provided. The secondary layer covering apparatus 40 includes a resin application apparatus 41 and an ultraviolet irradiation apparatus 42. The resin application apparatus 41 holds an ultraviolet curing resin composition (Hereinafter, this is referred to as a “secondary layer material”) as a covering material for forming the secondary layer 4. The secondary layer material is applied to the primary layer 3 by the resin application apparatus 41.

The ultraviolet irradiation apparatus 42 is provided under the resin application apparatus 41. The ultraviolet irradiation apparatus 42 may have a configuration similar to that of the ultraviolet irradiation apparatus 32. The bare optical fiber 2 covered with the secondary layer material enters the ultraviolet irradiation apparatus 42, and the secondary layer material is irradiated with ultraviolet light. As a result, the secondary layer material is cured to form the secondary layer 4. The coated optical fiber 6 is formed by covering the bare optical fiber 2 with the primary layer 3 and the secondary layer 4.

The resin application apparatus 31 may be configured to separately hold the primary layer material and the secondary layer material. In this case, the resin application apparatus 31 applies the primary layer material to the bare optical fiber 2, and subsequently applies the secondary layer material on the primary layer material.

The ultraviolet irradiation apparatus 32 irradiates the primary layer material and the secondary layer material applied to the bare optical fiber 2 with ultraviolet light. Thus, the primary layer 3 and the secondary layer 4 are formed. In this case, the manufacturing apparatus 10 does not necessarily need to have the secondary layer covering apparatus 40.

The guide roller 45 and the winding apparatus 50 are provided under the secondary layer covering apparatus 40. The manufactured coated optical fiber 6 is guided by the guide roller 45 and wound by the winding apparatus 50.

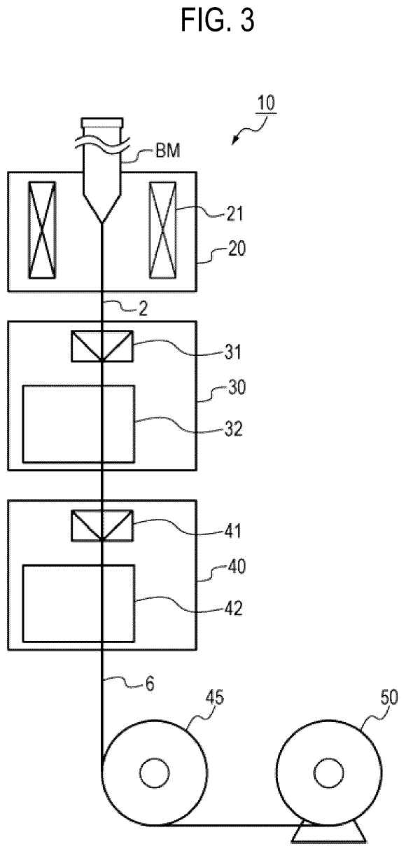

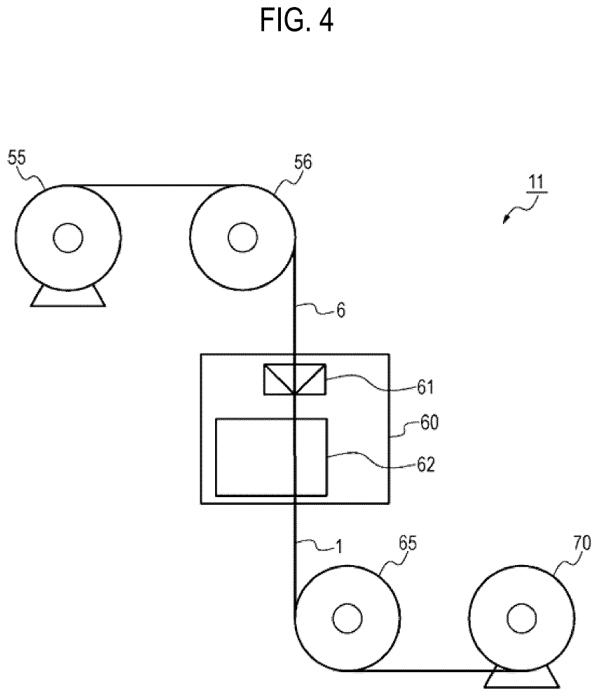

FIG. 4 is a schematic diagram illustrating a manufacturing apparatus 11 used in the method for manufacturing the colored optical fiber 1 according to the present embodiment. In FIG. 4, the manufacturing apparatus 11 includes a coated optical fiber holding apparatus 55, a guide roller 56, a colored layer covering apparatus 60, a guide roller 65, and a winding apparatus 70. The manufacturing apparatus 11 manufactures the colored optical fiber 1 from the coated optical fiber 6 manufactured by the plurality of manufacturing apparatuses 10 illustrated in FIG. 3.

The coated optical fiber holding apparatus 55 holds the manufactured coated optical fiber 6 in a wound state. In FIG. 4, the coated optical fiber holding apparatus 55 is a different apparatus from the winding apparatus 50, but the winding apparatus 50 may also serve as the coated optical fiber holding apparatus 55.

The colored layer covering apparatus 60 is provided under the coated optical fiber holding apparatus 55. The coated optical fiber 6 pulled out from the coated optical fiber holding apparatus 55 is guided by the guide roller 56 provided between the coated optical fiber holding apparatus 55 and the colored layer covering apparatus 60, and is conveyed into the colored layer covering apparatus 60.

The colored layer covering apparatus 60 includes a resin application apparatus 61 and an ultraviolet irradiation apparatus 62. The resin application apparatus 61 holds an ultraviolet curing resin composition (Hereinafter, this is referred to as “colored layer material”) as a covering material for forming the colored layer 5.

The colored layer material is applied to the coated optical fiber 6 by the resin application apparatus 61. The ultraviolet irradiation apparatus 62 is provided under the resin application apparatus 61. The ultraviolet irradiation apparatus 62 may be configured in the same manner as the ultraviolet irradiation apparatuses 32 and 42.

The coated optical fiber 6 covered with the colored layer material on the outer periphery of the secondary layer 4 enters the ultraviolet irradiation apparatus 62, and the colored layer material and the coated optical fiber 6 are irradiated with ultraviolet light. Thus, the colored layer material is cured to form the colored layer 5.

The colored optical fiber 1 is formed by covering the bare optical fiber 2 with the primary layer 3, the secondary layer 4, and the colored layer 5. The manufactured colored optical fiber 1 is guided by a guide roller 65 provided under the colored layer covering apparatus 60 and wound around a winding apparatus 70.

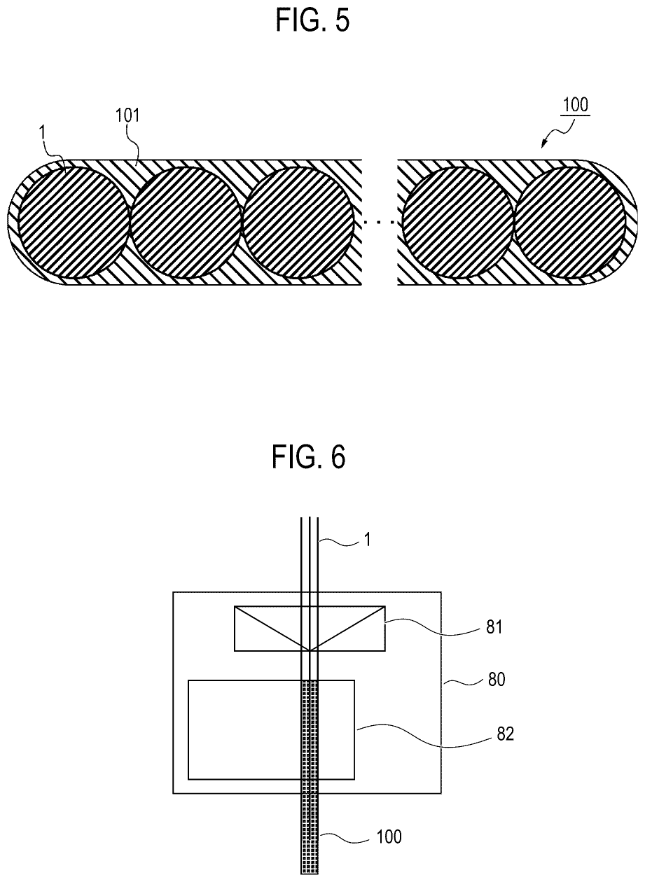

FIG. 5 is a cross-sectional view of the optical fiber ribbon 100 according to the present embodiment. The optical fiber ribbon 100 is configured by bundling a plurality of colored optical fibers 1 in a band shape via a ribbon layer 101.

The ribbon layer 101 is formed by irradiating a covering material containing an ultraviolet curing resin with ultraviolet light to cure the covering material. The ultraviolet curing resin forming the ribbon layer 101 is formed of the same resin as the ultraviolet curing resin forming the primary layer 3, the secondary layer 4, and the colored layer 5. The colored optical fiber 1 can be bundled at a high density by taking the form of the optical fiber ribbon 100. The optical fiber ribbon 100 is not limited to the configuration illustrated in FIG. 5. It may also take the form of an optical fiber ribbon cable in which the optical fiber ribbon 100 is housed by a sheath.

FIG. 6 is a schematic diagram of a ribbon forming apparatus 80 used in a method for manufacturing the optical fiber ribbon 100 according to the present embodiment. The ribbon forming apparatus 80 includes a resin application apparatus 81 and an ultraviolet light source 82. The resin application apparatus 81 holds an ultraviolet curing resin composition (Hereinafter, this is referred to as “ribbon layer material”), which is a covering material of the ribbon layer 101.

A plurality of prepared colored optical fibers 1 enter the ribbon forming apparatus 80, and the ribbon layer material is applied by the resin application apparatus 81. The colored optical fiber 1 applied to the ribbon layer material is bundled together with a plurality of other colored optical fibers 1 applied to the ribbon layer material. The bundled plurality of colored optical fibers 1 are irradiated with ultraviolet light by the ultraviolet light source 82 provided in the ribbon forming apparatus 80. As a result, the ribbon layer material is cured to form the ribbon layer 101. A plurality of colored optical fibers 1 arranged in parallel are connected via the ribbon layer 101. In this way, the optical fiber ribbon 100 is formed from the colored optical fiber 1 having a small diameter.

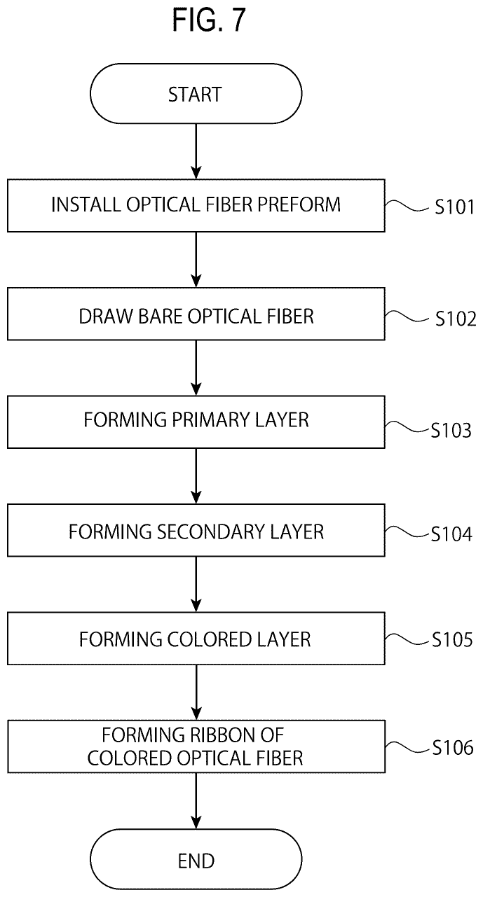

FIG. 7 is a flowchart of a method for manufacturing the colored optical fiber 1 and the optical fiber ribbon 100 according to the present embodiment. First, a user installs the optical fiber preform BM in the manufacturing apparatus 10 (step S101).

Next, the heater 21 provided in the heating apparatus 20 heats the optical fiber preform BM and starts drawing the bare optical fiber 2 (step S102).

The primary layer covering apparatus 30 applies the primary layer material around the drawn bare optical fiber 2 and irradiates the primary layer material with ultraviolet light to form the primary layer 3 (step S103). At this time, the primary layer 3 and the bare optical fiber 2 are reversibly coupled to each other to be in close contact with each other.

Next, the secondary layer covering apparatus 40 applies the secondary layer material around the primary layer 3 and irradiates the secondary layer material with ultraviolet light to form the secondary layer 4 (step S104). Thus, the coated optical fiber 6 is obtained. The manufactured coated optical fiber 6 is wound by the winding apparatus 50.

Subsequently, when the coated optical fiber 6 is pulled out from the coated optical fiber holding apparatus 55 or the winding apparatus 50, the colored layer covering apparatus 60 applies the colored layer material around the secondary layer 4 of the coated optical fiber 6 and irradiates the colored layer material with ultraviolet light to form the colored layer 5 (step S105). By covering the colored layer 5 around the coated optical fiber 6, the colored optical fiber 1 is obtained. The manufactured colored optical fiber 1 is wound around the winding apparatus 70.

In the step of forming the primary layer 3 (step S103), ultraviolet irradiation is not necessarily required. In this case, the primary layer 3 can be cured in the step of forming the secondary layer 4 (step S104).

After the colored layer 5 is formed in step S105, the ribbon forming apparatus 80 applies the ribbon layer material so as to cover the plurality of prepared colored optical fibers 1, and irradiates the ribbon layer material with ultraviolet light to connect the plurality of colored optical fibers 1 to each other (step S106). Thus, the optical fiber ribbon 100 is manufactured. The structure of the optical fiber ribbon 100 is not limited to that described above, as long as a plurality of colored optical fibers 1 are gathered. In FIG. 7, in the step of forming the primary layer 3 (step S103), the primary layer material is irradiated with ultraviolet light to cure the primary layer material, but the irradiation timing is not limited thereto. In the step of forming the secondary layer 4 (step S104), the primary layer material and the secondary layer material may be cured by irradiating the primary layer material and the secondary layer material with ultraviolet light.

Further, the Young's modulus measurement (P-ISM) of the primary layer 3 is defined as having been measured by the following method. First, using a commercially available stripper, the primary layer 3 and the secondary layer 4 of the intermediate portion of the optical fiber serving as a sample are peeled off by a length of several millimeters, and then one end of the optical fiber on which the covering layer is formed is fixed on the slide glass with an adhesive, and a load F is applied to the other end of the optical fiber on which the covering layer is formed. In this state, a displacement δ of the primary layer 3 at the boundary between the portion where the covering layer is peeled off and the portion where the covering layer is formed is read by a microscope. Then, by setting the load F to 10, 20, 30, 50, and 70 gf (that is, 98, 196, 294, 490, and 686 mN sequentially), a graph of the displacement δ with respect to the load F is created. Then, the primary elastic modulus is calculated using the slope obtained from the graph and the following equation (1). Since the calculated primary elastic modulus corresponds to the so-called ISM, the primary elastic modulus is appropriately referred to as P-ISM in the following description. When drawing the colored optical fiber 1, the drawing speed and the illuminance of the ultraviolet were controlled in order to adjust the P-ISM.

P-ISM=(3F/δ)*(1/2π1)*ln(DP/DG) equation (1)

Here, the unit of P-ISM is [MPa]. Further, F/δ is an inclination indicated by a graph of the displacement (δ) [μm] with respect to the load (F) [gf], l is a sample length (for example, 10 mm), and DP/DG is a ratio between the outer diameter (DP) [μm] of the primary layer 3 and the outer diameter (DG) [μm] of the cladding portion of the optical fiber. Therefore, in the case of calculating P-ISM from F, δ, and 1 used, it is necessary to perform predetermined unit conversion. The outer diameter of the primary layer 3 and the outer diameter of the cladding portion can be measured by observing the cross section of the optical fiber cut by the fiber cutter with a microscope. In general, the Young's modulus of the primary layer 3 may be in the range of 0.1 to 3.0 MPa.

A method for measuring the Young's modulus of the secondary layer 4 is as follows. The optical fiber is immersed in liquid nitrogen, and the covering is stripped by a stripper to pull out the glass optical fiber from the optical fiber, thereby preparing a covering-only sample. Next, the end portion of the sample is fixed to an aluminum plate with an adhesive. Next, a portion of the aluminum plate is chucked in an atmosphere having a temperature of 23° C. and a relative humidity of 50% using a Tensilon universal tensile tester. Next, the sample is pulled at a marking interval of 25 mm and a pulling rate of 1 mm/min, and the force at the time of 2.5% stretching is measured. Then, an elastic modulus (secondary elastic modulus) S-ISM (2.5% secant modulus) of the secondary layer is calculated based on the measured value. In general, the Young's modulus of the secondary layer 4 can be in the range of 500 to 2000 MPa.

When the colored layer 5 of the colored optical fiber 1 is formed, an ultraviolet curing resin composition containing a coloring ink is used. Examples of the color of the coloring ink include black, gray, purple, blue, aqua, green, yellow, orange, brown, pink, red, and white. In general, the Young's modulus of the colored layer 5 can be in the range of 500 to 2000 MPa.

A method for measuring the Young's modulus of the ribbon layer 101 is as follows. The ribbon layer 101 scraped off using an unused blade is subjected to state adjustment at a constant temperature and humidity (23° C., 50%), and then a sample piece having a length of 25 mm is prepared. Next, under the condition of constant temperature and constant humidity (23° C., 50%), the sample is pulled at a pulling rate of 1 mm/min, and the force at the time of 2.5% stretching is measured. Then, the elastic modulus of the ribbon layer 101 is calculated based on the measured force at the time of stretching. The cross-sectional area of the sample piece is measured with a microscope. In general, the Young's modulus of the ribbon layer 101 may be in the range of 1.0 to 2000 MPa.

In the present embodiment, an optical fiber having an effective core cross-sectional area (effective core cross-sectional area) Aeff of 60 μm² or more (≥60 μm²) is used as the optical fiber. In the optical fiber, Aeff is an index of microbend sensitivity, and a larger Aeff indicates a higher microbend sensitivity. In general, when the effective core cross-sectional area exceeds 100 μm², it is said that the microbend sensitivity is high. In particular, when Aeff is equal to or greater than 130 μm² and equal to or less than 150 μm², the optical fiber has high microbend sensitivity without any problem. The effective core cross-sectional area (effective core cross-sectional area) Aeff is expressed by (MFD)²×π×k/4 (Here, MED is a mode field diameter (μm), and k is a constant.), and is described in, for example, C-3-76 and C-3-77 of the Institute of Electronics and Communications Engineers of Electronics and Society of Electronics and Communications, 1999. It is also assumed that Aeff is measured at 1550 nm.

There are various methods of measuring microbend loss. In the present specification, A microbend loss value defines a difference between a transmission loss of an optical fiber to be measured in a state A in which optical fibers having a length of greater than or equal to 400 m are wound around a large bobbin wound a sandpaper #1000 thereon in one layer so as not to overlap each other with a tension of 100 gf, and a transmission loss of an optical fiber in state B wound on the same bobbin as state A with the same tension and length as state A which is not wound around a sandpaper. Here, the transmission loss of the optical fiber in the state B does not include the microbend loss, and is considered to be a transmission loss inherent to the optical fiber itself.

This measuring method is similar to the fixed diameter drum method defined in JIS C6823:2010. This measuring method is also referred to as a sandpaper method. Further, in this measuring method, since the transmission loss is measured at a wavelength of 1550 nm, the following microbend loss in the present specification is also a value at a wavelength of 1550 nm.

### EXAMPLES

Next, Examples 1-6 and Comparative Examples 1-2 of the coated optical fiber 6 according to the present invention will be described. In Examples 1-6 and Comparative Examples 1-2, a delamination recovery test was performed by the following method. First, partial peeling (delamination) was caused by applying a local load to the side surface of the coated optical fiber 6. Thereafter, the optical fiber was stored in an atmosphere at a temperature of 23° C. and a relative humidity of 50%, and the state of delamination with time was observed with a microscope. The delamination recovery test was performed after one month or more had elapsed after the optical fiber was drawn.

In Examples 1-6 and Comparative Examples 1-2, a pull-out force test was performed by the following method. First, one end of an optical fiber from which a covering layer was stripped off by several mm by using a commercially available stripper was fixed to one of two sheets of paper (10 mm×50 mm) arranged 10 cm apart by an adhesive. In addition, another end of the optical fiber was fixed to the other piece of paper with the adhesive. The prepared sample was stored overnight in an atmosphere at a temperature of 23° C. and a relative humidity of 50%, and the sample was pulled at a pulling rate of 5 mm/min, and the maximum applied load was read. Note that the pull-out force test was performed after one month or more after the optical fiber was drawn.

Further, in Examples 1-6 and Comparative Examples 1-2, a critical adhesion force test was performed by the following method. First, one end of an optical fiber from which a covering layer was stripped off by several using a commercially available stripper was fixed to one of two sheets of paper (10 mm×50 mm) arranged at a distance of 21 cm with an adhesive. In addition, the other end of the optical fiber was fixed to the other piece of paper by the adhesive. Next, a load of 30 to 180 g was applied to the prepared sample under high temperature and high humidity (constant at 60° C. and 98%), and the time from the application until the optical fiber dropped was recorded. The applied load was plotted against the time until the optical fiber dropped. Among the plurality of applied loads plotted, the applied load as the Knee point was defined as the critical adhesion force.

In Examples 1-6 and Comparative Examples 1-2, any one of the silane coupling agent A, the silane coupling agent B, and the silane coupling agent C having the following chemical formula was added to the common ultraviolet curing resin (urethane acrylate). The silane coupling agent A was a compound synthesized using 1,6-hexanediol (manufactured by Tokyo Chemical Industry Co., Ltd.) and 3-isocyanatopropyltrimethoxysilane (manufactured by Tokyo Chemical Industry Co., Ltd.) as raw materials. The silane coupling agent B was a compound synthesized using polypropylene glycol (Mn to 1000, manufactured by SIGMA-ALDRICH) and 3-isocyanatopropyltrimethoxysilane (manufactured by Tokyo Chemical Industry Co., Ltd.) as raw materials. The silane coupling agent C was a commercially available silane coupling agent (manufactured by Tokyo Chemical Industry Co., Ltd.).

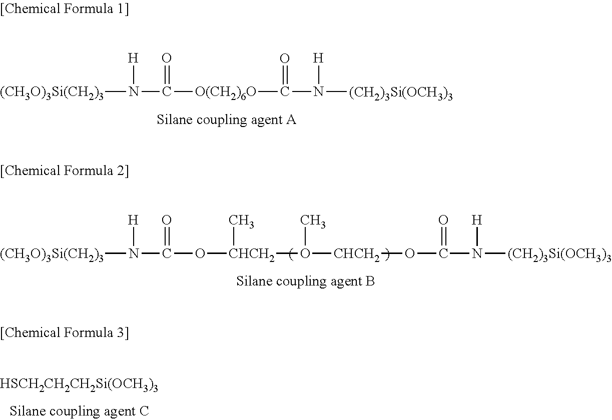

The diol is not limited to (1,6-hexanediol) and polypropylene glycol, and may be, for example, (1,7-heptanediol) and polyethylene glycol. In the case of an oligomer polymer such as polypropylene glycol or polyethylene glycol, the molecular weight is not particularly limited. Each of the silane coupling agent A and the silane coupling agent B includes a portion in which a urethane bond is formed in a molecular structure. Therefore, the portion where the urethane bond is formed in the ultraviolet curing resin constituting the primary layer 3 and the portion where the urethane bond is formed in the silane coupling agent form a hydrogen bond. Hydrogen bond is easily cleaved under high temperature or high humidity. In addition, since the hydrogen bond is cut, the critical adhesive force is lowered. That is, when the extraction force is sufficiently high and the critical adhesion force is low, it can be considered that the bare optical fiber 2 and the primary layer 3 are in close contact with each other by hydrogen bond.

In Examples 1-6, a silane coupling agent having two urethane bonds in its molecular structure and having methoxysilyl groups at both ends was used as in the case of the silane coupling agent A or the silane coupling agent B, but the molecular structure of the silane coupling agent is not limited to this structure. The molecular structure of the silane coupling agent may be any as long as it has a functional group that forms one or more reversible bonds between the bare optical fiber 2 and the primary layer 3 as illustrated in the following chemical formula. In the following chemical formula, x represents an integer of 1 to 3. Y represents an integer of 0 to 2. X+y≤3. R¹ represents an alkoxy group, an acetoxy group, or a halogen group. R² represents H or CH₃. R³ represents a molecular chain containing a functional group which partially forms one or more reversible bonds between the bare optical fiber 2 and the primary layer 3. R³ may include, for example, a functional group such as an alkoxysilyl group, an acetoxysilyl group, or a halosilyl group.

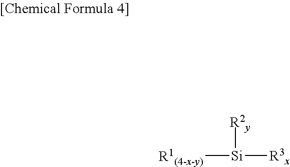

The equivalent (K) of the portion where the bare optical fiber 2 and the primary layer 3 form the reversible bond is calculated according to the following equation (2). Here, N represents the number of portions where the bare optical fiber 2 and the primary layer 3 form the reversible bond in one molecule of the silane coupling agent. Wt represents the mass of the silane coupling agent per 100 g of the ultraviolet curing resin composition forming the primary layer 3. Mn is the theoretical molecular weight of the silane coupling agent.

K=(N*Wt)/Mn (Equation 2) . . . equation (2)

For example, in the case of the silane coupling agent A, N=2 and Mn=528.8 g/mol because of the molecular structure having two urethane bonds. In the case of the silane coupling agent B, N=2 and Mn=1328.5 g/mol because of the molecular structure having two urethane bonds.

The conditions (type, addition amount, and equivalent) of the silane coupling agent and the results of various tests on the coated optical fiber 6 in Examples 1-6 and Comparative Example 1-2 are illustrated in Table 1 below.

TABLE 1

| | | | | Optical fiber | | |
|---|---|---|---|---|---|---|
| | | | | | | Critical |
| | Additive | | | | Pull-out | adhesion |
| | Silane coupling agent | | | Delamination recovery test | force | force |
| | — | wt % | Equivalent | — | N | N |
| Example 1 | A | 0.10 | 0.00038 | Higher degree of recovery than Comparative Examples 1 and 2 | 1.83 | 0.49 |
| Example 2 | A | 0.67 | 0.0025 | Higher degree of recovery than Comparative Examples 1 and 2 | 5.46 | 0.88 |
| Example 3 | A | 2.02 | 0.0076 | Higher degree of recovery than Comparative Examples 1 and 2 | 14.74 | 1.37 |
| Example 4 | B | 0.42 | 0.00063 | Higher degree of recovery than Comparative Examples 1 and 2 | 2.82 | 0.49 |
| Example 5 | B | 1.69 | 0.0025 | Higher degree of recovery than Comparative Examples 1 and 2 | 2.80 | 0.49 |
| Example 6 | B | 5.07 | 0.0076 | Higher degree of recovery than Comparative Examples 1 and 2 | 3.45 | 0.88 |
| Comparative | C | 0.20 | — | — | 1.77 | 0.49 |
| Example 1 | | | | | | |
| Comparative | C | 0.50 | — | — | 3.74 | 1.37 |
| Example 2 | | | | | | |

### Example 1

In the coated optical fiber 6 of Example 1, the primary layer 3 was formed using a primary layer material in which 0.10 wt % of the silane coupling agent A was added to the ultraviolet curing resin (urethane acrylate). In the coated optical fiber 6 of Example 1, the degree of recovery of delamination was higher than that of the optical fiber using the silane coupling agent C (Comparative Example 1 and Comparative Example 2). In addition, the pull-out force in the coated optical fiber 6 of Example 1 was 1.83 N, and the critical adhesion force was 0.49 N. It is considered that the bare optical fiber 2 and the primary layer 3 are bonded to each other by hydrogen bond in the coated optical fiber 6 because the critical adhesion force is low with respect to the extraction force.

### Example 2

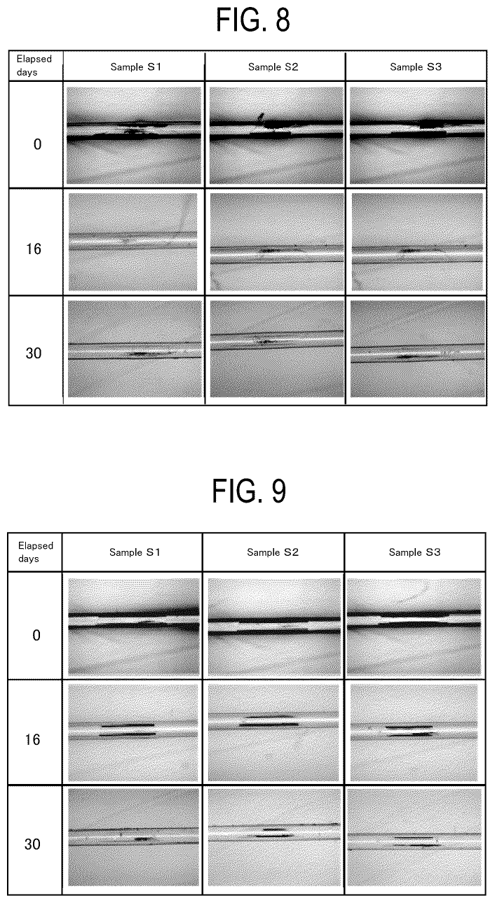

In the coated optical fiber 6 of Example 2, the primary layer 3 was formed using a primary layer material in which 0.67 wt % of the silane coupling agent A was added to the ultraviolet curing resin (urethane acrylate). In the coated optical fiber 6 of Example 2, the degree of recovery of delamination was higher than that of the optical fiber using the silane coupling agent C (Comparative Example; and Comparative Example 2). FIG. 8 is a graph illustrating the results of a delamination recovery test in Example 2. Here, the states of the three samples S1 to S3 when 0 days, 16 days, and 30 days have elapsed after the delamination is formed are illustrated. Delamination occurs in a portion indicated by black in FIG. 8. In the samples S1 to S3, it was observed that the delamination was recovered with the passage of days. In the coated optical fiber 6 of Example 2, the pull-out force was 5.46 N, and the critical adhesion force was 0.88 N. It is considered that the bare optical fiber 2 and the primary layer 3 are bonded to each other by hydrogen bond in the coated optical fiber 6 because the critical adhesion force is low with respect to the extraction force.

### Example 3

In the coated optical fiber 6 of Example 3, a primary layer was formed using a primary layer material in which 2.02 wt % of the silane coupling agent A was added to the ultraviolet curing resin (urethane acrylate). In the coated optical fiber 6 of Example 3, the degree of recovery of delamination was higher than that of the optical fiber using the silane coupling agent C (Comparative Example 1 and Comparative Example 2). In the coated optical fiber 6 of Example 3, the pull-out force was 14.74 N, and the critical adhesion force was 1.37 N. It is considered that the bare optical fiber 2 and the primary layer 3 are bonded to each other by hydrogen bond in the coated optical fiber 6 because the critical adhesion force is low with respect to the extraction force.

### Example 4

In the coated optical fiber 6 of Example 4, the primary layer 3 was formed using a primary layer material in which 0.42 wt % of the silane coupling agent B was added to the ultraviolet curing resin (urethane acrylate). In the coated optical fiber 6 of Example 4, the degree of recovery of delamination was higher than that of the optical fiber using the silane coupling agent C (Comparative Example 1 and Comparative Example 2). In the coated optical fiber 6 of Example 4, the pull-out force was 2.82 N, and the critical adhesion force was 0.49 N. It is considered that the bare optical fiber 2 and the primary layer 3 are bonded to each other by hydrogen bond in the coated optical fiber 6 because the critical adhesion force is low with respect to the extraction force.

### Example 5

In the coated optical fiber 6 of Example 5, the primary layer 3 was formed using a primary layer material in which 1.69 wt % of the silane coupling agent B was added to the ultraviolet curing resin (urethane acrylate). In the coated optical fiber 6 of Example 5, the degree of recovery of delamination was higher than that of the optical fiber using the silane coupling agent C (Comparative Example 1 and Comparative Example 2). In the coated optical fiber 6 of Example 5, the pull-out force was 2.80 N, and the critical adhesion force was 0.49 N. It is considered that the bare optical fiber 2 and the primary layer 3 are bonded to each other by hydrogen bond in the coated optical fiber 6 because the critical adhesion force is low with respect to the extraction force.

### Example 6

In the coated optical fiber 6 of Example 6, the primary layer 3 was formed using a primary layer material in which 5.07 wt % of the silane coupling agent B was added to the ultraviolet curing resin (urethane acrylate). In the coated optical fiber 6 of Example 6, the degree of recovery of delamination was higher than that of the optical fiber using the silane coupling agent C (Comparative Example 1 and Comparative Example 2). In the coated optical fiber 6 of Example 6, the pull-out force was 3.45 N, and the critical adhesion force was 0.88 N. It is considered that the bare optical fiber 2 and the primary layer 3 are bonded to each other by hydrogen bond in the coated optical fiber 6 because the critical adhesion force is low with respect to the extraction force.

### Comparative Example 1

In the coated optical fiber 6 of Comparative Example 1, the primary layer 3 was formed using a primary layer material in which 0.20 wt % of the silane coupling agent C was added to the ultraviolet curing resin (urethane acrylate). In the coated optical fiber 6 of Comparative Example 1, the pull-out force was 3.74 N, and the critical adhesion force was 1.37 N. In the coated optical fiber 6 of Comparative Example 1, unlike the case of Examples 1-6, sufficient recovery of delamination was not confirmed.

### Comparative Example 2

In the coated optical fiber 6 of Comparative Example 2, the primary layer 3 was formed using a primary layer material in which 0.50 wt % of the silane coupling agent C was added to the ultraviolet curing resin (urethane acrylate). FIG. 9 is a graph illustrating the results of a delamination recovery test in Comparative Example 2. Here, the states of the three samples S1 to S3 when 0 days, 16 days, and 30 days have elapsed after the delamination is formed are illustrated.

Delamination occurs in a portion indicated by black in FIG. 9. In the samples S1 to S3, it was observed that the delamination was recovered with the passage of days. However, the recovery of delamination in Comparative Example 2 was slower than that in Example 2. In the coated optical fiber 6 of Comparative Example 2, the pull-out force was 1.77 N, and the critical adhesion force was 0.49 N. In the coated optical fiber 6 of Comparative Example 2, unlike the case of Examples 1-6, sufficient recovery of delamination was not confirmed.

From the above results, it was found that, by reversibly bonding the bare optical fiber 2 and the primary layer 3 of the optical fiber, the recovery force of peeling (delamination) of the primary layer 3 from the bare optical fiber 2 caused by an external stimulus or the like becomes high while sufficiently maintaining the adhesion force between the bare optical fiber 2 and the primary layer 3.

The values of the pull-out force and the critical adhesion force vary depending on the structure (for example, diameter and thickness) of the covering layer in the optical fiber, physical properties such as Young's modulus of the primary layer, the molecular structure of the silane coupling agent (The number of portions for reversibly bonding the bare optical fiber 2 and the primary layer 3 in one molecule.), the amount of the silane coupling agent added, and the like. Therefore, the values of the pull-out force and the critical adhesion force illustrated in Examples 1-6 and Comparative Examples 1-2 are merely examples. In general, the pull-out force may be 1.0 to 20.0 N, and the critical adhesion force may be 0.10 to 3.0 N.

The present invention is not limited to the above-described embodiments, and various modifications are possible. For example, an example in which a part of the configuration of any of the embodiments is added to another embodiment, and an example in which a part of the configuration of another embodiment is replaced with another embodiment, are also embodiments of the present invention. In addition, a well-known technique or a publicly known technique in the technical field can be appropriately applied to a portion that is not particularly described or illustrated in the embodiment.

In the above-described embodiment, as an example of the reversible bond, the case where the portion where the urethane bond is formed in the ultraviolet curing resin and the portion where the urethane bond is formed in the silane coupling agent are hydrogen-bonded to each other has been described. Reversible bond is not limited solely to hydrogen bonds with urethane bond character. Even when reversible bonds other than hydrogen bonds are used, the degree of recovery of delamination can be increased.

In the above-described embodiment, the primary layer 3 includes the ultraviolet curing resin composition in which only the silane coupling agent that reversibly bonds the bare optical fiber 2 and the primary layer 3 is added to the ultraviolet curing resin. However, the composition of the ultraviolet curing resin composition is not limited thereto. An ultraviolet curing resin composition in which another silane coupling agent that irreversibly bonds the bare optical fiber 2 and the primary layer 3 to the ultraviolet curing resin is further added may be used. By using the silane coupling agent that reversibly couples the bare optical fiber 2 and the primary layer 3 and the silane coupling agent that irreversibly couples the bare optical fiber 2 and the primary layer 3 in combination, it is possible to secure the adhesion between the bare optical fiber 2 (glass) and the primary layer 3.

What is claimed is:

1. An ultraviolet curing resin composition for forming a primary layer in a colored optical fiber that includes a bare optical fiber, the primary layer covering the bare optical fiber, and a secondary layer covering the primary layer, comprising: a silane coupling agent that reversibly bonds the bare optical fiber and the primary layer.

2. The ultraviolet curing resin composition according to claim 1, wherein the silane coupling agent is a compound that does not include a functional group for irreversibly bonding the bare optical fiber and the primary layer.

3. The ultraviolet curing resin composition according to claim 1, further comprising: another silane coupling agent that irreversibly bonds the bare optical fiber and the primary layer.

4. The ultraviolet curing resin composition according to claim 1, wherein the silane coupling agent includes a portion reversibly bonding the bare optical fiber and the primary layer in an amount of 0.00038 equivalents or more per 100 g of the ultraviolet curing resin composition.

5. The ultraviolet curing resin composition according to claim 1,
wherein the silane coupling agent is a compound represented by the following Chemical Formula I, 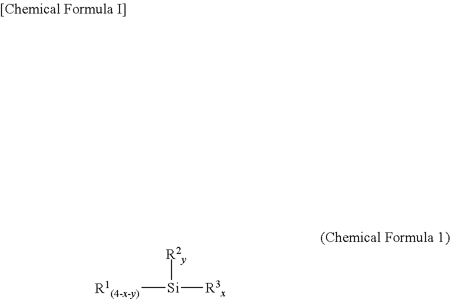
wherein the Chemical Formula I, x represents an integer of 1 to 3, y represents an integer of 0 to 2, and x+y≤3, R¹ is an alkoxy group, an acetoxy group, or a halogen group, R² is H or CH₃, R³ is a molecular chain partially containing a functional group which forms one or more reversible bonds between the bare optical fiber and the primary layer.

6. The ultraviolet curing resin composition according to claim 1, wherein the silane coupling agent reversibly bonds the bare optical fiber and the primary layer by any of hydrogen bond, dynamic covalent bond, ionic bond, and bonding by intermolecular force.

7. The ultraviolet curing resin composition according to claim 1, wherein the silane coupling agent includes any of a carboxy group, a hydroxy group, and an ester group.

8. The ultraviolet curing resin composition according to claim 1, wherein an ultraviolet curing resin and the silane coupling agent that constitute the ultraviolet curing resin composition have a molecular structure including a portion where a urethane bond is formed, and
wherein the portion of the ultraviolet curing resin and the portion of the silane coupling agent are bonded to each other by hydrogen bond.

9. A coated optical fiber comprising:
a bare optical fiber;
a primary layer that is formed of a first ultraviolet curing resin composition and covers the bare optical fiber; and
a secondary layer that is formed of a second ultraviolet curing resin composition and covers the primary layer,
wherein the first ultraviolet curing resin composition includes a silane coupling agent that reversibly bonds the bare optical fiber and the primary layer.

10. A colored optical fiber comprising:
the coated optical fiber according to claim 9; and
a colored layer that is formed of a third ultraviolet curing resin composition and covers the secondary layer of the coated optical fiber.

11. A colored optical fiber comprising:
a coated optical fiber according to claim 9,
wherein the coated optical fiber has a colored secondary layer.

12. An optical fiber ribbon comprising:
a plurality of the colored optical fibers according to claim 10; and
a ribbon layer that is formed of a fourth ultraviolet curing resin composition for covering the plurality of colored optical fibers, and connects the plurality of colored optical fibers.

13. A method for manufacturing a coated optical fiber comprising:
a step of drawing a bare optical fiber from an optical fiber preform;
a step of forming a primary layer by applying a first ultraviolet curing resin composition around the bare optical fiber; and
a step of forming a secondary layer by applying a second ultraviolet curing resin composition around the primary layer; and
a step of irradiating ultraviolet light to cure the first ultraviolet curing resin composition and the second ultraviolet curing resin composition,
wherein the first ultraviolet curing resin composition includes a silane coupling agent that reversibly bonds the bare optical fiber and the primary layer.

14. The method for manufacturing a coated optical fiber according to claim 13, wherein in the step of forming the primary layer, the first ultraviolet curing resin composition is irradiated with the ultraviolet light.

15. A method for manufacturing a colored optical fiber comprising:
a step included in the method for manufacturing a coated optical fiber according to claim 13;
a step of forming a colored layer by applying a third ultraviolet curing resin composition containing a colorant around the secondary layer.

16. The method for manufacturing a colored optical fiber according to claim 15, wherein in the step of forming the primary layer, the first ultraviolet curing resin composition is irradiated with the ultraviolet light.

17. A method for manufacturing a colored optical fiber comprising:
a step included in the method of manufacturing a coated optical fiber according to claim 13,
wherein the second ultraviolet curing resin composition contains a colorant.

18. A method for manufacturing a colored optical fiber comprising:
a step included in the method of manufacturing a coated optical fiber according to claim 13,
wherein in the step of forming the primary layer, the first ultraviolet curing resin composition is irradiated with the ultraviolet light.

19. A method for manufacturing optical fiber ribbon comprising:
a step of forming a ribbon layer that connects the plurality of colored optical fibers by applying a fourth ultraviolet curing resin composition around the plurality of colored optical fibers manufactured by the method for manufacturing a colored optical fiber according to claim 15 and irradiating the fourth ultraviolet curing resin composition with the ultraviolet light.
